(19) United States
(12) Patent Application Publication
(10) Pub. No.: US 2015/0114950 A1
(43) Pub. Date: Apr. 30, 2015

(54) HEATING DEVICE

(71) Applicant: BorgWarner Ludwigsburg GmbH, Ludwigsburg (DE)

(72) Inventors: John Kelly, Athea (IE); Martin Dowling, Tralee (IE)

(21) Appl. No.: 14/527,240

(22) Filed: Oct. 29, 2014

(30) Foreign Application Priority Data
Oct. 31, 2013 (DE) 10 2013 112 043.1
Dec. 19, 2013 (DE) 10 2013 114 471.3

(51) Int. Cl. H05B 3/04; H05B 3/03; H05B 3/32

(52) U.S. Cl. CPC H05B 3/04; H05B 3/32; H05B 3/03
USPC 219/534; 219/541; 219/552

(57) ABSTRACT

The disclosure refers to a heating device comprising a flat tube, a ceramic heating element arranged in the flat tube, a contact sheet contacting the heating element, a sheet of electrically insulating ceramic electrically insulating the contact sheet from the flat tube, a frame holding the heating element and the contact sheet. According to this disclosure, the frame is made of an elastomer and has two sealing sections that each seal an end of the flat tube.

### RELATED APPLICATIONS

This application claims priority to DE 10 2013 112 043.1, filed Oct. 31, 2013, and also claims priority to DE 10 2013 114 471.3, filed Dec. 19, 2013, both of which are hereby incorporated herein by reference in their entireties.

### BACKGROUND AND SUMMARY

The present invention relates to a heating device of the type generally known from DE 10 2006 018 784 A1. Such heating devices are used, e.g., for heating the interior of automobiles. This disclosure teaches an improvement to the reliability of such heating devices.

In a heating device according to this disclosure, the frame is made of an elastomer and has two sealing sections that each seal an end of the flat tube in which one or more ceramic heating elements are arranged. A frame made of an elastomer instead of thermoplastic material allows a waterproof seal of flat tubes with no or little additional effort. By sealing the flat tube of a heating device it can be protected from damage by moisture or water. Thus the reliability of the heating device can be improved.

The elastomer may for example be a silicon elastomer. Silicone elastomers, especially fluorine silicone elastomers, have the advantage of being highly temperature resistant.

According to a refinement of this disclosure, the elastomer has a Shore A hardness of 50 to 75. A frame made of an elastomer with such hardness can be easily handled during assembly and also enables a watertight seal, especially if the flat tube is compressed after the frame has been inserted into the tube.

A heating device according to this disclosure may be used, e.g., for the interior of a vehicle or for heating a pump of a vehicle.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a sectional view of a heating device; and

FIG. 2 shows another sectional view of the heating device.

### DETAILED DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

In this disclosure, terms such as “vertical,” “parallel,” “horizontal,” “flat,” “round,” “rectangular” and the like are used to describe the orientation, position or general shape of structural elements disclosed herein. As would be readily recognized by one of ordinary skill, it shall be understood for purposes of this disclosure and claims that these terms are not used to connote exact mathematical orientations or geometries, unless explicitly stated, but are instead used as terms of approximation. With this understanding, the term “vertical,” for example, certainly includes a structure that is positioned exactly 90 degrees from horizontal, but should generally be understood as meaning positioned up and down rather than side to side. Other terms used herein to connote orientation, position or shape should be similarly interpreted.

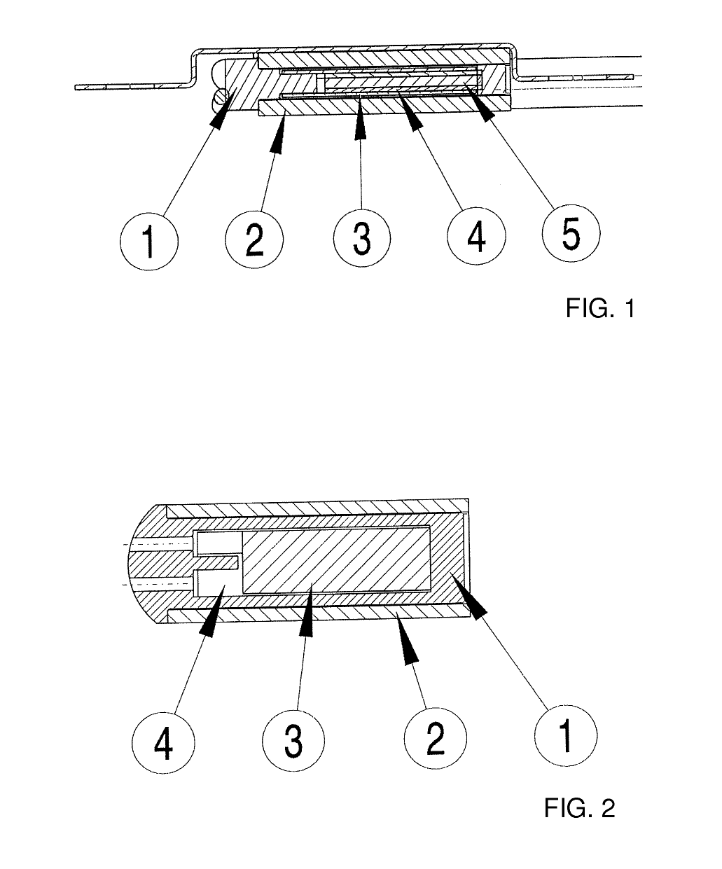

The heating device shown in FIGS. 1 and 2 comprises a ceramic heating element 5, e.g., a PTC heating element, a flat tube 2, in which the ceramic heating element 5 is arranged, a contact sheet 4, which contacts the ceramic heating element 5 inside the flat tube 2, a frame 1 holding the ceramic heating element 5 and the contact sheet 4, and an insulating sheet 3, which electrically insulates the contact sheet from the flat tube 2.

The sectional view of FIG. 1 shows the heating device cut along a plane that is perpendicular to the broad sides of the flat tube 2. FIG. 2 shows the heating device cut along a plane that is parallel to the broad sides of the flat tube 2.

The frame 1 is made of an elastomer, e.g., a silicone elastomer. The frame 1 forms two sealing sections that each seals an end of flat tube 2. The flat tube 2 is compressed after the frame 1, the ceramic heating element 5, the contact sheet 4, and the insulating sheet 3 have been inserted into the flat tube 2. Thereby the sealing sections are compressed and a watertight seal of the flat tube 2 achieved. The frame 1 may be made of an elastomer having a Shore A hardness of 50 to 75. The frame 1 made of an elastomer provides for an ingress protection rating of IP67.

In the embodiment shown, there is only a single ceramic heating element 3. The flat tube 2 may contain additional ceramic heating elements 5 that are also held by the frame 2, e.g., by clamping. The at least one ceramic heating element 5 may be electronically contacted on one side by a contact sheet 4 and on the other side by the flat tube 2. In the embodiment shown, there are two contact sheets 4 between which the ceramic heating element or elements 5 are arranged. Each contact sheet 4 has an insulating sheet 3, e.g., made of ceramic, on its backside and touches the ceramic heating element or elements 5 with its front side.

The contact sheet 4 or sheets can protrude from the flat tube 2. It is also possible that the contact sheet or sheets 4 are connected inside the flat tube 2 to an electrical lead, e.g., a wire. The flat tube 2 and the contact sheet or sheets 4 can be made of aluminium or an aluminium based alloy, for example.

The frame 1 may hold the ceramic heating element or elements 5 by clamping. It is also possible to injection mould the frame 1 around an assembly of contact sheets or sheets 4 and one or more ceramic heating elements 5.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### REFERENCE NUMERALS

1 frame

2 flat tube

3 insulating sheet

4 contact sheet

5 ceramic heating element

What is claimed is:

1. Heating device, comprising:
a flat tube;
a ceramic heating element arranged in the flat tube;
a contact sheet electrically contacting the heating element;
a sheet of electrically insulating ceramic electrically insulating the contact sheet from the flat tube; and
a frame holding the heating element and the contact sheet;
wherein the frame is made of an elastomer and has two sealing sections that each seal an end of the flat tube.

2. Heating device according to claim 1, wherein the flat tube is plastically deformed by compressing after insertion of the frame.

3. Heating device according to claim 1, wherein the flat tube is made of aluminium or an aluminium based alloy.

4. Heating device according to claim 1, wherein the elastomer is a silocone elastomer.

5. Heating device according to claim 1, wherein the elastomer has a Shore A hardness of 50 to 75.

6. Heating device according to claim 1, wherein the frame is an injection moulded frame and that the heating element and the contact sheet or sheets are overmoulded by the frame.

7. Heating device according to claim 1, wherein the frame holds the heating element by clamping.
